(19) United States
(12) Patent Application Publication
(10) Pub. No.: US 2024/0359149 A1
(43) Pub. Date: Oct. 31, 2024

(54) GRANULAR PRODUCT DISCHARGE FLAP SYSTEM FOR DOSING SYSTEMS

(71) Applicant: Gençler Elektronik Sanayi Ve Ticaret Limited Sirketi, Istanbul (TR)

(72) Inventor: Hakan Eksi, Ikitelli/Istanbul (TR)

(73) Assignee: Gençler Elektronik Sanayi Ve Ticaret Limited Sirketi, Istanbul (TR)

(21) Appl. No.: 18/565,081

(22) PCT Filed: Nov. 2, 2021
(86) PCT No.: PCT/TR2021/051112

§ 371 Date: Nov. 28, 2023

(30) Foreign Application Priority Data
Oct. 14, 2021 (TR) 2021/016062

(51) Int. Cl. B01F 35/80; B01F 35/88; G01F 13/00

(52) U.S. Cl. CPC B01F 35/892; B01F 35/883; G01F 13/001

(57) ABSTRACT

The invention relates to a granular product discharge flap system which is employed in dosing systems, enables discharging very fine doses of the relevant materials without any losses of time and labor, and reduces assembly and disassembly times in cases of repair and maintenance requiring intervention in the system.

### TECHNICAL FIELD

The invention relates to a granular product discharge flap system which is employed in dosing systems, enables discharging very fine doses of the relevant materials without any losses of time and labor, and reduces assembly and disassembly times in cases of repair and maintenance requiring intervention in the system.

### BACKGROUND ART

Dosing systems are essentially structures enabling the entry and exit of granular materials and their derivatives by rationing or weighing them by opening and closing of the system via flaps. These systems are comprised of raw material loaders which are the first entry points for the materials, storage chambers, flap systems, weighing chambers for weighing the material, and mixing chambers.

Flap systems are structures that are controlled by automation for stopping the flowing material and discharging it by opening the flap when needed. Properties of the flap system are its mechanical structure, its opening-closing speed, the adjustability of the active flow area of the material, and ease of use of the system.

In terms of repair and maintenance of the system, easy access to and unlabored assembly and disassembly of the flap systems are of utmost importance. Patent document no. US2003185095 in the prior art mentions a dosing system. The disassembly of the flap system of the said invention and the subsequent maintenance procedure take a quite long time since the flaps are connected to the storage chambers, making intervention difficult.

The flap system opens and closes with mechanical movements. The operating forces of these mechanical movements in the linear field and the frequency of system failure or mechanical problems directly affect the efficiency of dosing systems. Additionally, as seen in patent no. US2003185095, the flaps are connected to the frame of the system from a single point. This increases the load on this system; mechanical and failure predisposition of the system do not make it possible to operate without problems for a long time. Moreover, the single-point connection of the flaps increases its circular path, negatively affecting the opening and closing speed of the flaps. The frequent occurrence of these problems and challenging maintenance of the systems considerably decrease efficiency.

Considering the flap systems in the prior art, the adjustability of the active flow area of the material in the system is quite important. In patent no. US2003185095, metal wings that narrow or expand the area should be disassembled and adjusted in order to adjust the active area. In the current techniques, the need to disassemble the system to adjust the active flow area of the material leads to too much time and extra labor to be dedicated to this procedure.

In other U.S. Pat. Nos. 6,969,044B2 and 3,998,426A in the prior art, the flap systems function only as opening and closing elements; they do not contain a structure that can narrow or expand the flow area when needed. This makes the user unable to adjust the relevant area.

As seen in patents no. US2003185095, U.S. Pat. Nos. 6,969,044B2, and 3,998,426A, extracting material from the system in case of any repair, maintenance, or part change procedure either takes a long time or is not possible at all in the existing flap systems. Different methods are applied for the extraction procedure; this includes vacuuming from the weighing scale, manually removing from the material storage chamber, or disassembling the flap system to remove the material therein.

In conclusion, the abovementioned problems in the existing flap systems, as well as the inadequacy of the current solutions, entail an improvement in the respective field.

### DESCRIPTION OF THE INVENTION

The present invention relates to a flap system that is employed in dosing systems and enables discharging very fine doses of the relevant materials.

An objective of the invention is to ensure assembling and disassembling the flap system without any losses of time and labor if and when needed.

Another objective of the invention is to ensure finely adjusting the area where the concerned product actively flows, without any losses of time and labor.

A further objective of the invention is to ensure easy discharge of the raw material contained in the flap system and storage chamber, without any losses of time and labor.

Another objective of the invention is to ensure smooth operation of the system for the longest time by minimizing mechanical issues thanks to the mechanical structure and properties targeting the minimization of errors and malfunctions.

A further objective of the invention is to make the system lighter and easier to carry by opting for conductive plastic material.

Structural and characteristic features of the invention, as well as all of its advantages, will be understood more clearly with the figures given below and the detailed description written by referring to the relevant figures. Therefore, the evaluation should be made by taking into consideration of the said figures and detailed description.

### DRAWINGS

The applications of the present invention that is briefly summarized above and addressed in detail below can be understood by referring to the sample applications depicted in the attached drawings of the invention. However, it must be stated that the attached drawings show only the typical applications of this invention and that since the invention allows other equally effective applications, its scope cannot be assumed to be limited.

FIG. 1: It is a left perspective view of the present invention.

FIG. 2: It is a right perspective view of the present invention.

FIG. 3: It is a side view of the flaps in the open position.

FIG. 4: It is a side view of the flaps in the closed position.

FIG. 5: It is a cross-sectional view of the flow adjustment plate in the wide position.

FIG. 6: It is a cross-sectional view of the flow adjustment plate in the narrow position.

In order to facilitate understanding, identical reference numbers are used to indicate identical elements in the figures, where possible. The shapes are not drawn to scale and can be simplified for clarity. It is believed that the elements and features of an application can be usefully incorporated into other applications without further explanation.

### EXPLANATION OF DETAILS IN THE DRAWINGS

Explanations of reference numbers shown in the drawings are given below.
1. Frame
2. Fast assembly holes
3. Piston
4. Pin
5. Material outlet wall
6. Air hose
7. Holding handle
8. Flow handle
9. Connecting element
10. Flap
11. Discharge hose
12. Discharge hose cover
13. Flow adjustment plate
14. Valve
15. Main air inlet
16. Nut
17. Mechanism fixing plate

### DETAILED EXPLANATION OF THE INVENTION

The preferred alternatives in this detailed description of the embodiment of the granular product discharge flap (10) system for dosing systems of the present invention are only intended for providing a better understanding of the subject matter and should not be construed in any restrictive sense.

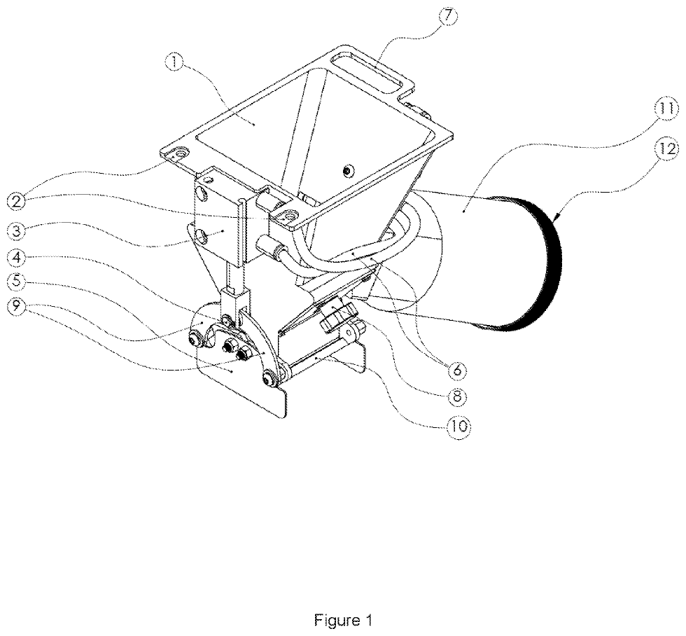

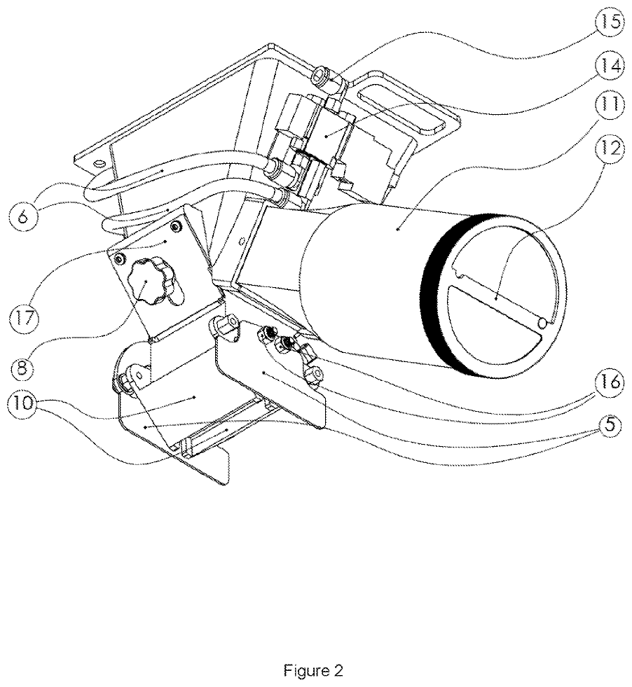

The granular product discharge flap (10) system for dosing systems of the present invention consists of a finished frame (1) enabling product entry and exit and allowing the mechanical parts to be positioned thereon. This frame (1) is the main element of the invention where other elements are connected. This frame (1) is preferably made of conductive plastic. On the frame (1), a holding handle (7) is found, ensuring a safe manual grip of the product during assembly and disassembly. There are fast assembly holes (2) on the frame (1), enabling the assembly of the product by sliding. Under the fast assembly holes (2), a piston (3) is located to provide the motion needed for opening and closing the flap (10) on the frame (1). A connecting element (9) connects the piston (3) and the flaps (10). This connecting element (9) ensures the connection between the piston (3) and the flap (10) with a pin (4). FIG. 1 and FIG. 2 present perspective views of the present invention.

Underneath the system, a material outlet wall (5) is placed to prevent the material exiting the system from being spilled and scattered around. Nuts (16) are employed to fix the material outlet walls (5) and the flaps (10) onto the frame (1). The invention consists of a valve (14) enabling opening and closing the piston (3), an air hose (6) ensuring the airflow between the valve (14) and the piston (3), and a main air inlet (15) allowing the entry of the air required by the system therein.

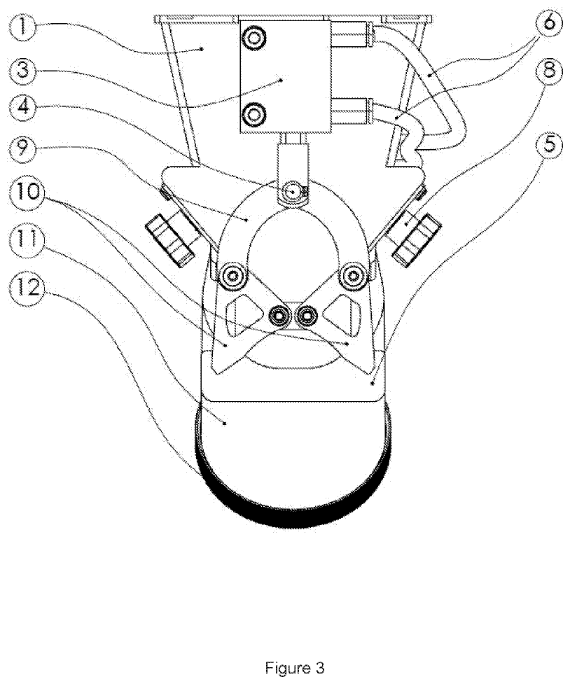

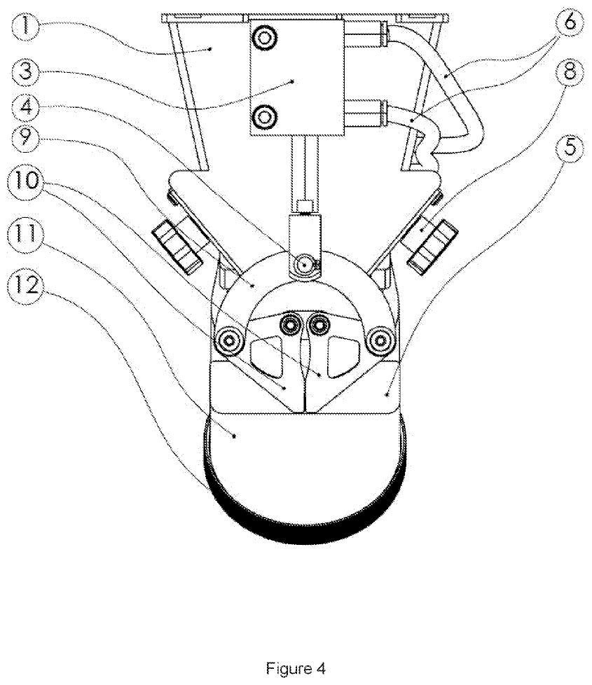

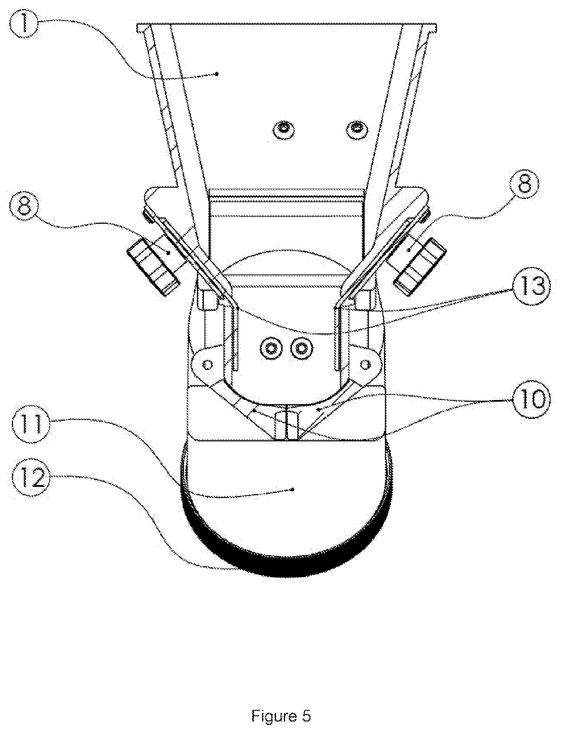

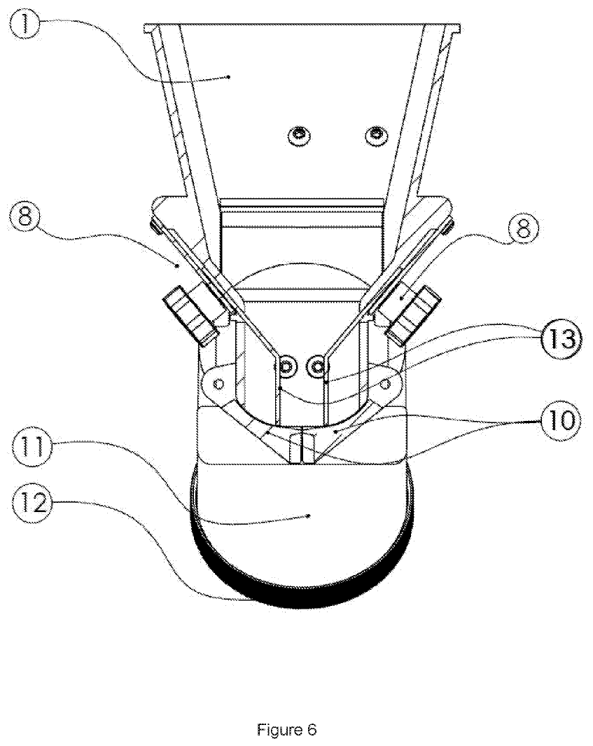

The system of the present invention has flaps (10) starting and stopping the material flow by opening and closing. These flaps (10) are preferably made of stainless steel. The operating speed and modus operandi of the flaps are of utmost significance. The flaps (10) are connected to the frame (1) at two separate force points with the help of the nuts (16). FIG. 3 shows a view of the flaps (10) in the open position while FIG. 4 is a view of the flaps (10) in the closed position. In this system, adjusting the flow area inside the system during the raw material flow is highly important. In the invention, a flow handle (8) is employed to adjust the relevant flow area. The flow handle (8) is connected to the frame (1) with a mechanism fixing plate (17). These flow handles (8) provide the movement of a flow adjustment plate (13) located in the interior of the flaps (10), thereby enabling narrowing and expanding the flow area. FIG. 5 and FIG. 6 are cross-sectional views of the flow adjustment plate (13) in the wide and narrow positions. Accordingly, the flow area can be adjusted thanks to the flow handles (8) and the flow adjustment plate (13), without the need for any assembly and disassembly procedures. The flaps (10) and the flow adjustment plates (13) enable the invention to discharge products at fine doses and adjustable flow areas.

[symbol] lischarge hose (11) is included to fully expel the raw material from the system. This discharge hose (11) is preferably made of conductive plastic. On the discharge hose (11), a discharge hose cover (12) that can be manually opened and closed is located. The discharge hose cover (12) also is preferably made of conductive plastic.

1. A granular product discharge flap system which is employed in dosing systems, enables discharging very fine doses of the relevant materials, and reduces assembly and disassembly times in cases of repair and maintenance requiring intervention in the system, and its feature is that it is characterized in that it consists of:
a finished frame (1) enabling product entry and exit, allowing the mechanical parts to be positioned thereon, and being preferably made of conductive plastic;
fast assembly holes (2) enabling the assembly of the product by sliding;
a piston (3) providing the motion needed for opening and closing the flap (10);
a pin (4) ensuring the connection between the piston (3) and a connecting element (9);
a material outlet wall (5) preventing the exiting material from being spilled around;
an air hose (6) ensuring the airflow between a valve (14) and the piston (3)
a holding handle (7) allowing to hold the product during assembly and disassembly;
a flow handle (8) enabling to adjust the relevant flow area;
a connecting element (9) connecting the piston (3) and the flap (10);
flaps (10) starting and stopping the material flow by opening and closing, wherein they are preferably made of stainless steel;
a discharge hose (11) allowing to fully expel the raw material from the system and being preferably made of conductive plastic;
a discharge hose cover (12) ensuring manual opening and closing of the discharge hose (11) and being preferably made of conductive plastic;
a flow adjustment plate (13) being located in the interior of the flaps (10) and enabling narrowing and expanding the flow area with the help of the flow handles (8),
a valve (14) enabling opening and closing the piston (3):
a main air inlet (15) allowing the entry of the air required by the system therein;
the nuts (16) fixing the material outlet wall (5) and the flaps (10) onto the frame (1);
a mechanism fixing plate (17) enabling connecting the flow handle (8) to the frame (1).
